(19) United States
(12) Patent Application Publication
(10) Pub. No.: US 2018/0246360 A1
(43) Pub. Date: Aug. 30, 2018

(54) DISPLAY PANEL, DISPLAY APPARATUS, MANUFACTURING METHOD OF DISPLAY PANEL AND MANUFACTURING METHOD OF DISPLAY APPARATUS

(71) Applicants: BOE TECHNOLOGY GROUP CO., LTD., BEIJING (CN); BEIJING BOE DISPLAY TECHNOLOGY CO., LTD., BEIJING (CN)

(72) Inventors: Xueqiang QIAN, Beijing (CN); Zhenyu ZHANG, Beijing (CN); Yuqiong CHEN, Beijing (CN); Lifeng LIN, Beijing (CN); Mengjie WANG, Beijing (CN); Dongchuan CHEN, Beijing (CN); Shuai YUAN, Beijing (CN)

(21) Appl. No.: 15/576,643

(22) PCT Filed: May 17, 2017
(86) PCT No.: PCT/CN2017/084667

§ 371 Date: Nov. 22, 2017

(30) Foreign Application Priority Data
Jun. 12, 2016 (CN) 201610405873.X

(51) Int. Cl. G02F 1/1339; G02F 1/1362

(52) U.S. Cl. CPC G02F 1/13394; G02F 1/136286; G02F 1/133512; G02F 2202/28; G02F 2001/13398

(57) ABSTRACT

The present disclosure relates to a display panel, a display apparatus, a manufacturing method of a display panel and a manufacturing method of a display apparatus. The display panel comprises a first substrate and a second substrate, the display panel being divided into a display region and a non-display region, wherein a bonding element including an adhesive is disposed in the display region between the first substrate and the second substrate.

### CROSS REFERENCE TO RELATED APPLICATIONS

This application is a U.S. National Stage under 35 U.S.C. § 371 of International Application No. PCT/CN2017/084667, filed on May 17, 2017, which claims priority to and the benefit of Chinese application No. 201610405873.X filed on Jun. 12, 2016 and entitled “DISPLAY PANEL, DISPLAY APPARATUS, MANUFACTURING METHOD OF DISPLAY PANEL AND MANUFACTURING METHOD OF DISPLAY APPARATUS”, the disclosure of which is hereby incorporated by reference in its entirety.

### TECHNICAL FIELD

The present disclosure relates to a display panel, a display apparatus, a manufacturing method of a display panel and a manufacturing method of a display apparatus.

### BACKGROUND

With the development of LCD splicing screen technology, a higher requirement has been put forward for the frame width of LCD panels. Due to a limit on the width of a frame on which a sealant is applied, it is difficult to further reduce the edge width of the frame while retaining certain adhesion strength. This is disadvantageous to the manufacturing of a panel with a narrow frame.

### SUMMARY

In a first aspect of the present disclosure, a display panel is provided, comprising a first substrate and a second substrate, the display panel being divided into a display region and a non-display region, wherein a bonding element including an adhesive is disposed in the display region between the first substrate and the second substrate.

In an embodiment, the bonding element further comprises spacers, the adhesive being provided between the spacers, for preventing diffusion of the adhesive.

In an embodiment, the spacers and the adhesive are alternately disposed in multiple layers.

In an embodiment, the bonding element further comprises spacers, wherein the adhesive is doped in the spacers.

In an embodiment, the bonding element is in a band shape.

In an embodiment, one of the first substrate and the second substrate may be a color filter substrate including a black matrix; the projection of the bonding element on the color filter substrate overlaps the projection of the black matrix on the color filter substrate.

In an embodiment, one of the first substrate and the second substrate may be an array substrate including signal lines and gate lines, the projection of the bonding element on the array substrate overlaps the projection of the signal lines on the array substrate and/or the projection of the bonding element on the array substrate overlaps the projection of the gate lines on the array substrate.

In an embodiment, the adhesive comprises an epoxy acrylic resin, an acrylic resin, a thermal curing agent and a photoinitiator.

A second aspect of the present disclosure provides a display apparatus including the display panel described above.

A third aspect of the present disclosure provides a manufacturing method of a display panel, comprising: providing a first substrate and a second substrate, the display panel being divided into a display region and a non-display region; and disposing a bonding element on one of the first substrate and the second substrate, the bonding element including an adhesive and being located in the display region.

In an embodiment, disposing the bonding element comprises: disposing the spacers so that the adhesive is disposed between the spacers.

In an embodiment, the spacers and the adhesive are alternately disposed in multiple layers.

In an embodiment, the bonding element further comprises spacers, wherein the adhesive is doped in the spacers.

In an embodiment, the bonding element is in a band shape.

In an embodiment, disposing the spacers so that the adhesive is disposed between the spacers comprises: forming a spacer layer on one of the first substrate and the second substrate; patterning the spacer layer to form the spacers in the display region; providing the adhesive between the spacers.

In an embodiment, the manufacturing method of a display panel further comprises: attaching the first substrate to the second substrate; performing light curing and thermal curing on the adhesive.

In an embodiment, one of the first substrate and the second substrate may be a color filter substrate including a black matrix; the projection of the bonding element on the color filter substrate overlaps the projection of the black matrix on the color filter substrate.

In an embodiment, one of the first substrate and the second substrate may be an array substrate including signal lines and gate lines, the projection of the bonding element on the array substrate overlaps the projection of the signal lines on the array substrate and/or the projection of the bonding element on the array substrate overlaps the projection of the gate lines on the array substrate.

In an embodiment, the adhesive comprises an epoxy acrylic resin, an acrylic resin, a thermal curing agent and a photoinitiator.

A fourth aspect of the present disclosure provides a manufacturing method of a display apparatus comprising the manufacturing method of a display panel described above.

### BRIEF DESCRIPTION OF THE DRAWINGS

For a more clear illustration of the technical solutions of the embodiments of the present disclosure, a brief description of the drawings of the embodiments will be given below. It should be noted that the following description of the drawings merely involve some embodiments of the present disclosure, and is not a limitation of the present disclosure.

FIG. 1 is a schematic diagram of a display panel according to an embodiment of the present disclosure;

FIG. 2 is a schematic diagram of a display panel according to an embodiment of the present disclosure;

FIG. 3 is a schematic diagram of a method according to an embodiment of the present disclosure;

FIG. 4 is a schematic diagram of a display panel according to an embodiment of the present disclosure;

FIG. 5 is a schematic diagram of a display panel according to an embodiment of the present disclosure;

FIG. 6 is a schematic diagram of a display panel according to an embodiment of the present disclosure.

### DETAILED DESCRIPTION

In order to make objectives, technical schemes and advantages of the embodiments of the present disclosure more clear, a clear and complete description will be given below for the technical solutions of the embodiments of the present disclosure with reference to the figures. Obviously, embodiments described are only some embodiments of the present disclosure, and are not all of embodiments thereof. All other embodiments obtained by persons of ordinary skill in the art based on the embodiments of the present disclosure without creative efforts shall fall within the protection scope of the present disclosure.

In the discussion of elements and other embodiments of the present disclosure, the expression in the singular form in this description and the claims will include the expression in the plural form unless the context clearly indicates otherwise, and vice-versa. Thus, terms discussed in the singular generally also include the same terms in the plural. Terms “include”, “comprise”, “contain”, “have” are intended to express the meaning of “inclusion”, not excluding the presence of other elements than those listed herein.

Note that in the description of embodiments of the present disclosure herein, words such as upper, lower, left, right, upward, downward, top, and bottom for describing positional relationships between respective members and directions merely indicate positional relationships and directions in the drawings. Terms “cover on”, “on the top of . . . ”, “located on . . . ” or “located on the top of . . . ” mean that a first element such as a first structure is located on a second element such as a second structure, wherein there may be an intermediate element such as an interface structure between the first element and the second element. The term “contact” means that a first element such as a first structure is connected to a second element such as a second structure, with or without other element(s) at the interface between the two elements.

A display panel, a display apparatus, a manufacturing method of a display panel and a manufacturing method of a display apparatus are provided in embodiments of the present disclosure, capable of solving the conflict between the requirement for narrow frames in the convention art and the strength of adhesion between substrates.

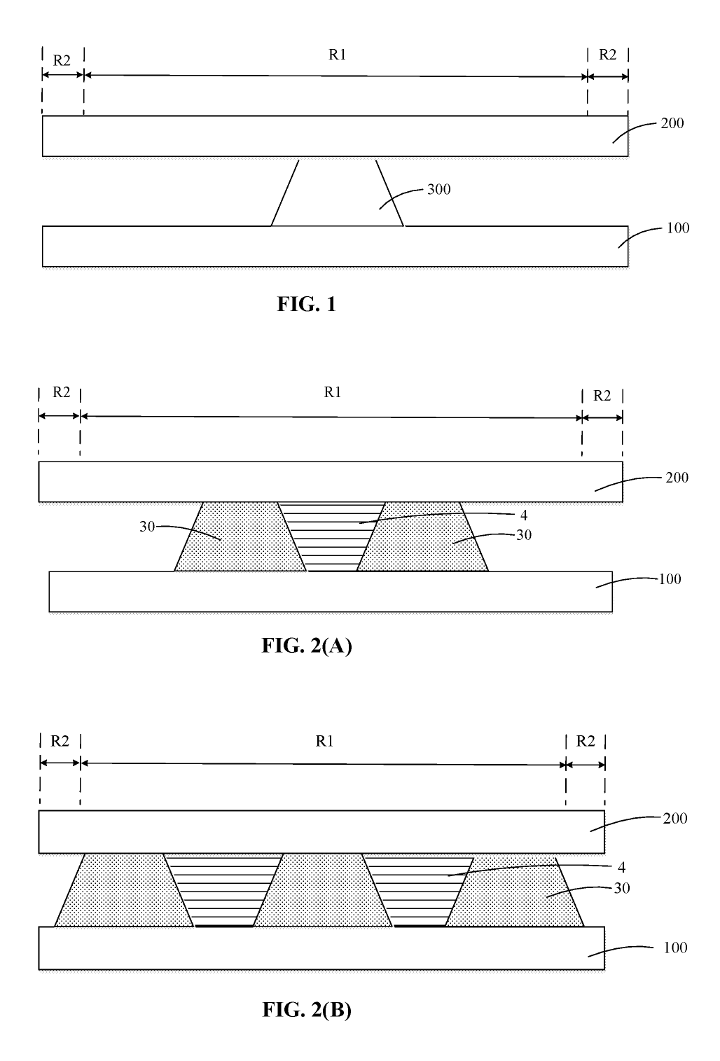

FIG. 1 is a schematic diagram of a display panel according to an embodiment of the present disclosure. As shown in FIG. 1, the display panel comprises a first substrate 100 and a second substrate 200. The display panel is divided into a display region R1 and a non-display region R2, wherein the non-display region R2 is located on the peripheral of the display region R1. A bonding element 300 is disposed in the display region R1 between the first substrate 100 and the second substrate 200, wherein the bonding element 300 comprises an adhesive. It should be noted that the cross section of the bonding element is trapezoidal, which is only an example, and the bonding element may have a cross section in any other suitable shapes according to practical needs.

According to the display panel provided in the embodiment of the present disclosure, a bonding element is disposed in the display region between the first substrate and the second substrate, wherein the bonding element comprises an adhesive, capable of increasing the contact size between the substrates, improving the strength of adhesion between the substrates and overcoming the drawback of the narrow frame process better.

The adhesive may have the same material as the frame sealant, such as a material including an epoxy acrylic resin, an acrylic resin, a thermal curing agent and a photoinitiator, or other materials can be used for the adhesive.

In an embodiment, the bonding element further comprises spacers, wherein the adhesive is doped in the spacers. The material of the spacer layer may comprise a photoinitiator, a monomer, a polymer, an additive and a solvent, for example, it may comprise an acrylate crosslinking agent and a photoinitiator or the like.

In another embodiment, the bonding element may further comprise spacers. The adhesive is provided between the spacers. The spacers are used to prevent diffusion of the adhesive. That is, the spacers and the adhesive are alternately disposed in a direction parallel to the extension direction of the first substrate, and the outermost portion of the bonding element is composed of spacers. The material of the spacer layer may comprise a photoinitiator, a monomer, a polymer, an additive and a solvent, for example, it may comprise an acrylate crosslinking agent and a photoinitiator or the like.

FIGS. 2(A) and 2(B) are schematic diagrams showing the display panel according to an embodiment of the present disclosure. In the embodiment shown in FIG. 2, the bonding element comprises an adhesive 4 and spacers 30. The adhesive 4 is located between the spacers 30, and the spacers 30 are used to prevent diffusion of the adhesive. As shown in FIG. 2(B), the spacers and the adhesive can also be alternately disposed in multiple layers. As shown in FIG. 2(A), in the illustrated embodiment, the bonding element has a three-layer structure, i.e., a structure in which a layer of adhesive is interposed between two layers of spacers. As shown in FIG. 2(B), in the illustrated embodiment, the bonding element has a five-layer structure, i.e., a structure in which a layer of adhesive is interposed between two layers of spacers. Be noted that any desired multiple-layer structures can be used for the bonding element, as long as the adhesive is disposed between spacers that are used to prevent diffusion of the adhesive (i.e., its the outermost portion is composed of spacers).

Different from conventional pillared spacers, the spacers according to the embodiment of the present disclosure may be in a band shape to prevent diffusion of the adhesive better. It can be understood that the spacers of the embodiment of the present disclosure can also serve as a supporter. Herein, spacers in a band shape means that the extending direction of the spacers is consistent with the extending direction of signal lines or gate lines located below the spacers. That is, particularly, in the case of a bonding element only disposed on signal lines of thin film transistors (TFTs), the extending direction of the spacers is consistent with the extending direction of the signal lines located below the spacers; in the case of a bonding element only disposed on gate lines of thin film transistors (TFTs), the extending direction of the spacers is consistent with the extending direction of the gate lines located below the spacers; in the case of a bonding element disposed on both signal lines and gate lines of thin film transistors (TFTs), the extending direction of the spacers is consistent with the extending direction of the signal lines and gate lines located below the spacers respectively.

According to the embodiment of the present disclosure, the bonding element may be in a band shape. If one of the first substrate and the second substrate is a color filter substrate including a black matrix, the projection of the bonding element on the color filter substrate overlaps the projection of the black matrix on the color filter substrate. If one of the first substrate and the second substrate is an array substrate including signal lines and gate lines, the projection of the bonding element on the array substrate overlaps the projection of the signal lines on the array substrate and/or the projection of the bonding element on the array substrate overlaps the projection of the gate lines on the array substrate. Herein “overlap” may comprise “completely overlap” or “partially overlap”.

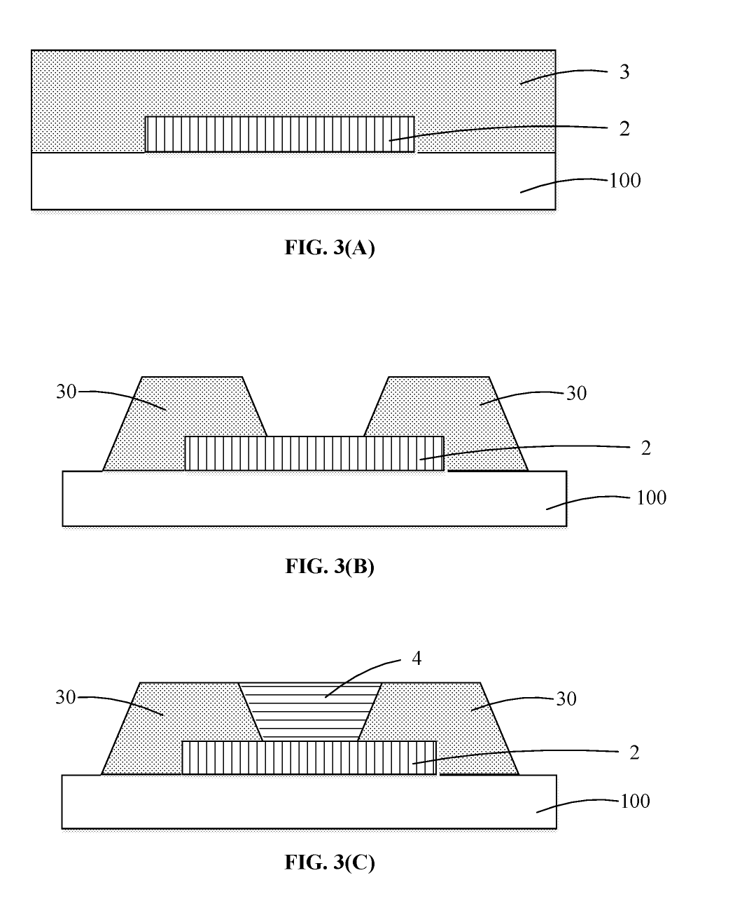

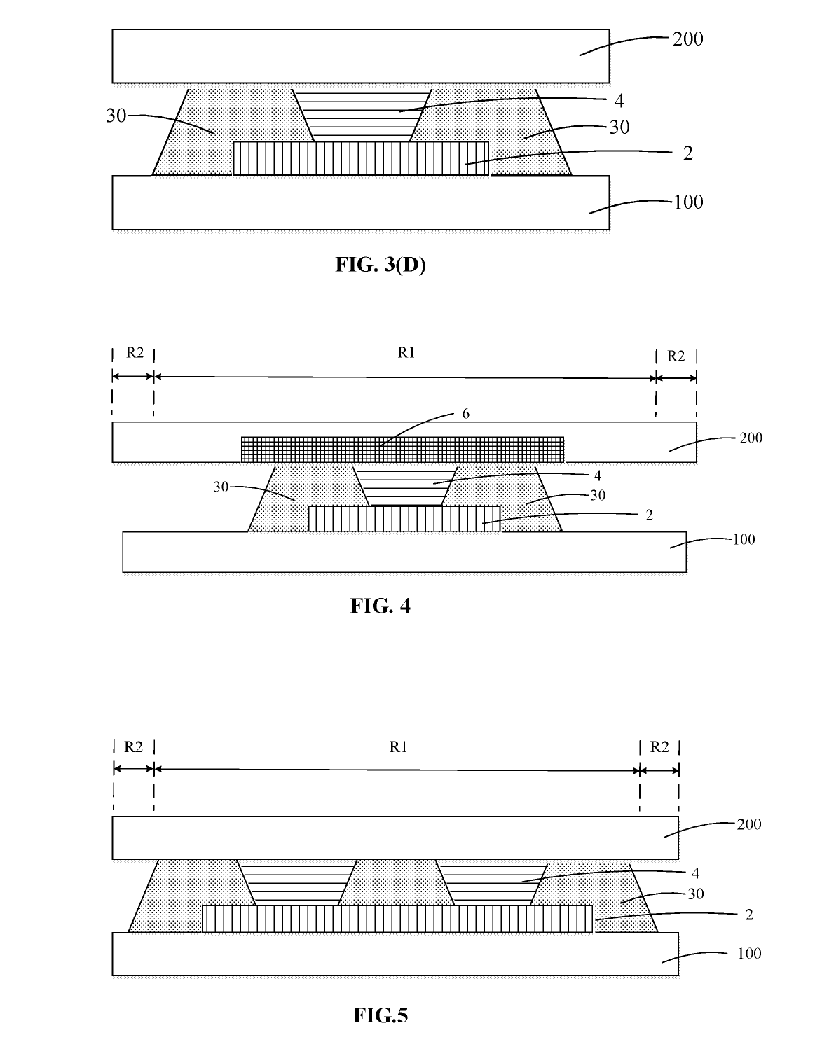

FIG. 3 is a manufacturing flow of a method according to an embodiment of the present disclosure. The manufacturing method of the embodiment of the present disclosure provides a technical solution that can achieve stronger adhesion strength between substrates with a narrowed frame. FIG. 3 illustrates spacers and an adhesive that are alternately disposed in multiple layers as an example.

One of the first substrate and the second substrate may be a color filter (CF) substrate. One of the first substrate and the second substrate may be a thin film transistor (TFT) substrate. Hereinafter, a description will be given with an example, in which the first substrate is a TFT substrate.

Particularly, in an embodiment, as shown in FIG. 3 (A), a first substrate (for example, TFT substrate) 100 is provided, then a conductive layer 2 is formed on the first substrate 100. The conductive layer 2 is used for at least one of signal lines and gate lines on the TFT substrate. Next, a spacer layer 3 is formed on the conductive layer 2 (for example, by deposition), so that the projection of the bonding element on the array substrate overlaps the projection of the signal lines on the array substrate and/or the projection of the bonding element on the array substrate overlaps the projection of the gate lines on the array substrate. It can be understood that, if the first substrate is a CF substrate, the spacer layer is formed on the CF substrate, and a portion of the spacer layer that will be preserved in a subsequent patterning process corresponds to a black matrix on the CF substrate, so that the projection of the bonding element on the CF substrate overlaps the projection of the black matrix on the CF substrate. The material of the spacer layer may comprise a photoinitiator, a monomer, a polymer, an additive and a solvent, for example, it may comprise an acrylate crosslinking agent and a photoinitiator or the like.

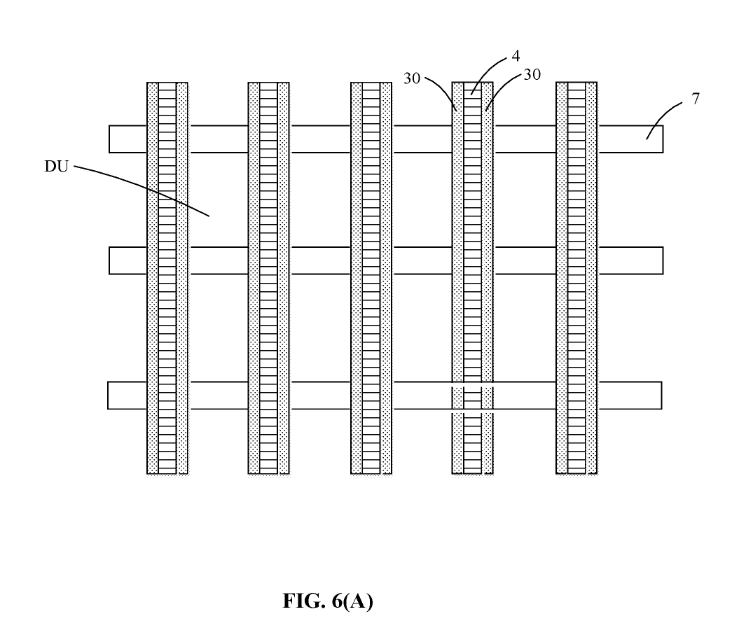

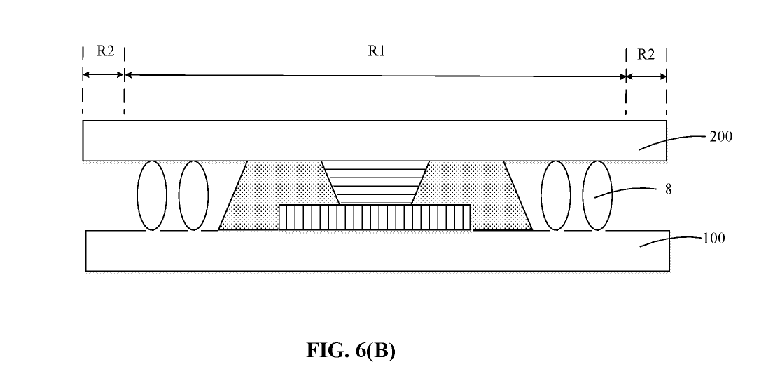

As shown in FIG. 3(B), the method further comprises patterning the spacer layer 3 to form the spacers 30 in the display region of the display panel. For the sake of preventing diffusion of the adhesive disposed subsequently, the spacers 30 may be set in a band shape. In an embodiment, the display region of the display panel comprises a plurality of display units, and the bonding element is located between at least a portion of the plurality of display units. A display unit can correspond to a sub-pixel (for example, a red sub-pixel, a green sub-pixel, a blue sub-pixel). A further description will be given below with reference to FIG. 6. It should be noted that the cross section of the bonding element shown in FIG. 3 is trapezoidal, which is only an example, and its cross section may be in any other suitable shapes according to practical needs.

As shown in FIG. 3 (C), the method further comprises forming an adhesive 4 between spacers 30. Particularly, in an embodiment, the adhesive can be filled in a spraying device with a nozzle that moves along a spraying path between two spacers to continuously spray the adhesive. The adhesive is used to increase the contact size between substrates and thereby improve the strength of adhesion between the substrates. The adhesive may have the same material as the frame sealant, such as a material including an epoxy acrylic resin, an acrylic resin, a thermal curing agent and a photoinitiator, or other materials can be used for the adhesive.

As shown in FIG. 3 (D), the method further comprises attaching the first substrate to the second substrate. Then, light curing is performed on the adhesive. For example, UV precuring can be performed from the side of the CF substrate using ultraviolet light. This method may further comprise performing thermal curing on the adhesive. For example, high temperature curing can be performed on the adhesive. Particularly, in an embodiment, after attaching the first substrate to the second substrate, the adhesive is irradiated by UV light from the side of the CF substrate for 40˜100 minutes, then the temperature increases to 80˜180° C., and the temperature is preserved for 1˜3 hours to completely thermally cure the adhesive.

Liquid crystals can be filled between the display units. The bonding element is such disposed that the projection of the bonding element on the array substrate overlaps the projection of the signal lines on the array substrate and/or the projection of the bonding element on the array substrate overlaps the projection of the gate lines on the array substrate (i.e., disposed on at least one of the signal lines and gate lines of the TFT substrate), without blocking light and having no influence on the aperture ratio of the pixels. Disposing the bonding element on the signal lines of the TFT substrate may further reduce the contamination of TFTs by the adhesive. The bonding element can be disposed in such a manner that the projection of the bonding element on the color filter substrate overlaps the projection of the black matrix on the CF substrate, without blocking light and having no influence on the aperture ratio of the pixels.

In the display panel provided according to the embodiment of the present disclosure, one of the first substrate and the second substrate may be a color filter (CF) substrate. One of the first substrate and the second substrate may be an array (Thin Film Transistor (TFT)) substrate. Hereinafter, a description will be given with an example in which the first substrate is a TFT substrate, the spacers and the adhesive are alternately disposed in multiple layers.

Particularly, in an embodiment, as shown in FIG. 4, the display panel is divided into a display region R1 and a non-display region R2, wherein the non-display region R2 is located on the peripheral of the display region R1. The display panel comprises a first substrate 100, a conductive layer 2 disposed on the first substrate 100, spacers 30, an adhesive 4 and a second substrate 200. Wherein, the conductive layer 2 is used for at least one of signal lines and gate lines on the TFT substrate. In the structure shown in FIG. 4, the spacers 30 and the adhesive 4 form a bonding element disposed in the display region between the first substrate and the second substrate. The array substrate 100 comprises signal lines and gate lines, the projection of the bonding element on the array substrate 100 overlaps the projection of the signal lines on the array substrate and/or the projection of the bonding element on the array substrate 100 overlaps the projection of the gate lines on the array substrate. The CF substrate 200 comprises a black matrix 6, and the projection of the bonding element on the CF substrate 200 overlaps the projection of the black matrix on the CF substrate 200. Herein “overlap” may comprise “completely overlap” or “partially overlap”.

It should be noted that the three-layer structure of the bonding element shown in FIG. 4 (i.e., a structure with a layer of adhesive interposed between two layers of spacers) is only an example, and is not used to limit the combination of the spacers and the adhesive. Any desired multiple-layer structures can be used for the bonding element, as long as its the outermost portion is composed of spacers. FIG. 5 is a schematic diagram of a bonding element having a five-layer structure according to an embodiment of the present disclosure. As shown in FIG. 5, the bonding element comprises a structure of five layers alternately disposed in a direction parallel to the extending direction of the first substrate, i.e., two layers of adhesive interposed between three layers of spacers respectively.

FIG. 6 is a schematic diagram of a display panel according to an embodiment of the present disclosure.

FIG. 6 (A) is a top view of the display panel. In FIG. 6, an illustration is given with the adhesive disposed on signal lines as an example. As shown in FIG. 6 (A), the gate lines are represented by reference sign 7. The gate lines and the signal lines cross with each other, so that the gate lines and the signal lines define a plurality of display units DU. In the embodiment shown in FIG. 6, the bonding element comprises spacers 30 and an adhesive 4 disposed between the spacers 30. It should be noted that the position of the bonding element can be specified according to needs, and is not limited to the position shown in the figure, as long as the bonding element is disposed in the display region of the display panel.

FIG. 6 (B) is a schematic view showing a portion of the cross section of the display panel. Compared with FIG. 4, liquid crystals 8 disposed in the display region (for example, various display units) are further shown in FIG. 6 (B).

The present disclosure provides a technical solution capable of achieving stronger adhesion strength between substrates with a narrowed frame. Through disposing a bonding element including an adhesive between at least a portion of a plurality of display units, the contact size between the substrates can be increased, thereby the strength of adhesion between the substrates is improved and the drawback of the narrow frame process can be overcome in a better manner.

The display apparatus in the embodiment of the present embodiment may be a mobile phone, a tablet computer, a TV, a notebook computer, a digital frame, a navigator or any other product or component having display function.

Although several embodiments of the present disclosure have been described above, these embodiments have been presented by way of example only, and are not intended to limit the scope of the present disclosure. Indeed, the novel embodiments described herein may be embodied in a variety of other forms. Furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

1. A display panel, comprising a first substrate and a second substrate, the display panel being divided into a display region and a non-display region, wherein a bonding element including an adhesive is disposed in the display region between the first substrate and the second substrate.

2. The display panel according to claim 1, wherein the bonding element further comprises spacers, the adhesive being provided between the spacers, for preventing diffusion of the adhesive.

3. The display panel according to claim 2, wherein the spacers and the adhesive are alternately disposed in multiple layers.

4. The display panel according to claim 1, wherein the bonding element further comprises spacers with the adhesive doped therein.

5. The display panel according to claim 2, wherein the bonding element is in a band shape.

6. The display panel according to claim 1, wherein one of the first substrate and the second substrate is a color filter substrate including a black matrix; and a projection of the bonding element on the color filter substrate overlaps a projection of the black matrix on the color filter substrate.

7. The display panel according to claim 1, wherein one of the first substrate and the second substrate may be an array substrate including signal lines and gate lines; the projection of the bonding element on the array substrate overlaps the projection of the signal lines on the array substrate and/or the projection of the bonding element on the array substrate overlaps the projection of the gate lines on the array substrate.

8. The display panel according to claim 5, wherein the adhesive comprises an epoxy acrylic resin, an acrylic resin, a thermal curing agent and a photoinitiator.

9. A display apparatus including the display panel according to claim 1.

10. A manufacturing method of a display panel comprising: providing a first substrate and a second substrate, the display panel being divided into a display region and a non-display region; and
disposing a bonding element on one of the first substrate and the second substrate, the bonding element including an adhesive and being located in the display region.

11. The manufacturing method of a display panel according to claim 10, wherein disposing the bonding element comprises: disposing spacers so that the adhesive is disposed between the spacers.

12. The manufacturing method of a display panel according to claim 11, wherein the spacers and the adhesive are alternately disposed in multiple layers.

13. The manufacturing method of a display panel according to claim 10, wherein the bonding element further comprises spacers with the adhesive doped therein.

14. The manufacturing method of a display panel according to claim 11, wherein the bonding element is in a band shape.

15. The manufacturing method of a display panel according to claim 14, wherein disposing the spacers so that the adhesive is disposed between the spacers comprises: forming a spacer layer on one of the first substrate and the second substrate;
patterning the spacer layer to form the spacers in the display region;
providing the adhesive between the spacers.

16. The manufacturing method of a display panel according to claim 15, further comprising:
attaching the first substrate to the second substrate;
performing light curing and thermal curing on the adhesive.

17. The manufacturing method of a display panel according to claim 10, wherein one of the first substrate and the second substrate is a color filter substrate including a black matrix; and a projection of the bonding element on the color filter substrate overlaps a projection of the black matrix on the color filter substrate.

18. The manufacturing method of a display panel according to claim 10, wherein one of the first substrate and the second substrate may be an array substrate including signal lines and gate lines; the projection of the bonding element on the array substrate overlaps the projection of the signal lines on the array substrate and/or the projection of the bonding element on the array substrate overlaps the projection of the gate lines on the array substrate.

19. The manufacturing method of a display panel according to claim 18, wherein the adhesive comprises an epoxy acrylic resin, an acrylic resin, a thermal curing agent and a photoinitiator.

20. A manufacturing method of a display apparatus comprising a manufacturing method of a display panel according to claim 10.
